(19) United States
(12) Patent Application Publication
(10) Pub. No.: US 2021/0219548 A1
(43) Pub. Date: Jul. 22, 2021

(54) USE OF FUNGICIDES AND GLYCINE BETAINE IN COMBINATION FOR CONTROLLING FUNGAL PLANT PATHOGENS

(71) Applicant: DANSTAR FERMENT AG, Zug (CH)

(72) Inventors: Jean-Marc Sanchez, Daux (FR); Olivier Cor, Saint Jean de Boiseau (FR); Thomas Doutreluingne, Lille (US)

(73) Assignee: DANSTAR FERMENT AG, Zug (CH)

(21) Appl. No.: 17/055,377

(22) PCT Filed: May 15, 2019
(86) PCT No.: PCT/EP2019/062536

§ 371 Date: Nov. 13, 2020

(30) Foreign Application Priority Data
May 15, 2018 (EP) 18290053.0

(51) Int. Cl. A01N 35/02; A01N 43/653; A01N 43/56

(52) U.S. Cl. CPC A01N 35/02; A01N 43/56; A01N 43/653

(57) ABSTRACT

The present disclosure concerns the use of a new combination for reducing the amount of fungicides required to control harmful fungal plant pathogens.

### TECHNOLOGICAL FIELD

The present disclosure relates to the combined use of fungicides and glycine betaine for controlling fungal plant pathogens.

### BACKGROUND

Fungicide use is arguably the most important component of pest and disease management programs in agricultural or horticultural production systems. This is because fungal diseases have the potential to destroy crops rendering them unsaleable. However, fungicides can act on organisms other than the target fungus, including other naturally occurring beneficial organisms. Also, because of their chemical nature, the regular use of fungicides can potentially pose a risk to the environment, particularly if residues persist in the soil or migrate off-site and enter waterways. If this occurs it could lead to adverse impacts to the health of terrestrial and aquatic ecosystems. Furthermore, consumers world-wide are increasingly conscious of the potential environmental and health problems associated with the residues of chemicals, particularly in food products. This has resulted in growing consumer pressure to reduce the use or at least the doses of chemical products (i.e. synthetic) spread in the environment.

FR2990107 discloses the use of glycine betaine demonstrates an antifungal effect by eliciting the natural defense systems of plants

FR2955231 discloses the use of glycine betaine to prevent and/or treat vine wood diseases (more particularly, to prevent esca).

U.S. Pat. No. 3,106,509 describes a fungicide comprising organic ferric ammonium arsonates. The fungicide can be combined with an auxiliary agent commonly used in agriculture.

US2009/0105238 describes an amphoteric compound characterized by a Zwitterionic structure of the betaine type having specific general formula which is used for the stimulation of the natural defense systems of plants from abiotic and biotic stress and the induction of resistance in the plants themselves.

Thus, there is an ongoing need for new methods and combinations for plant disease control. More particularly, there is a need to provide a method for controlling fungal plant pathogens which solves the problem of reducing the dosage rate of fungicides and thus the amount of residues in the crop and nevertheless provides sufficient disease control.

### BRIEF SUMMARY

The present disclosure relates to a method of reducing the amount of fungicides, more particularly of synthetic fungicides, while maintaining a similar fungicidal effect. The present disclosure more generally relates to the use of glycine betaine and at least one fungicide in combination.

This combination is advantageous in that it enables the use of lower amounts of fungicides (as, for example, synthetic fungicides), lowers the environmental impact of the fungicides and generally provides an efficient, selective and effective fungicidal composition.

The present disclosure thus relates to use of glycine betaine and at least one fungicide for controlling, treating and/or preventing at least one fungal plant pathogen and/or fungal disease in a plant. The present disclosure also relates to use of glycine betaine for reducing the amount of at least one fungicide applied to a plant to control, treat and/or prevent at least one fungal plant pathogen and/or fungal disease in the plant.

The present disclosure additionally relates to a method for controlling, treating and/or preventing at least one fungal plant pathogen and/or fungal disease in a plant comprising:

applying to the plant, soil or the vicinity of the plant a combination of glycine betaine and at least one fungicide. In an embodiment, the at least one fungicide is used or applied in an amount that is less than an amount of the at least one fungicide needed to control, treat and/or prevent the at least one fungal plant pathogen and/or fungal disease in the plant in the absence of glycine betaine. The amount of the at least one fungicide applied may be at least about 5%, at least about 10%, at least about 20%, at least about 30%, at least about 40%, or at least about 50%, about 60%, at least about 70%, at least about 80%, at least about 90%, or at least about 95% less than the amount of the at least one fungicide needed to control, treat and/or prevent the at least one fungal plant pathogen and/or fungal disease in the plant in the absence of glycine betaine.

The present disclosure also relates to a method for reducing the amount of at least one fungicide applied to a plant to control, treat and/or prevent at least one fungal plant pathogen and/or fungal disease in the plant comprising applying to the plant, soil or the vicinity of the plant a combination of glycine betaine and the at least one fungicide. The present disclosure further relates to a method for reducing the amount of at least one fungicide applied to a plant while maintaining fungicidal effect, the method comprising: applying to the plant, soil or the vicinity of the plant a combination of an amount of glycine betaine and an amount of at least one fungicide; wherein the amount of the at least one fungicide is less than the recommended dose for the at least one fungicide, wherein the amount of glycine betaine and the amount of the at least one fungicide applied to the plant achieve substantially the same fungicidal effect as would be achieved by application of the recommended dose of the at least one fungicide alone. In an embodiment, the reduction in amount of the at least one fungicide relative to the recommended dose is replaced by the amount of glycine betaine. In another embodiment, the amount of the least one fungicide replaced by the amount of glycine betaine is from about 5 wt % to about 95 wt %, from about 20 wt % to about 80 wt %, from about 35 wt % to about 65 wt %, from about 45 wt % to about 55 wt %, or about 50 wt %, of the recommended dose of the at least one fungicide. Alternatively, the amount of the at least one fungicide is at least about 5%, at least about 10%, at least about 20%, at least about 30%, at least about 40%, or at least about 50%, about 60%, at least about 70%, at least about 80%, at least about 90%, or at least about 95% less than the recommended dose for the at least one fungicide.

The present disclosure also relates to a method for reducing the amount of at least one fungicide applied to a plant while maintaining fungicidal effect, the method comprising: applying to the plant, soil or the vicinity of the plant a combination of glycine betaine and the at least one fungicide; wherein the at least one fungicide is applied to the plant in an amount less than the recommended dose for the at least one fungicide, and wherein the glycine betaine replaces from about 5 wt % to about 95 wt % of the recommended dose of the at least one fungicide. In an embodiment, the above described uses and methods achieve at least about 75%, at least about 80%, at least about 85%, at least about 90%, at least about 95%, or at least about 100% of the fungicidal effect as would be achieved by application of the recommended dose of the at least one fungicide alone.

The present disclosure further relates to a composition comprising glycine betaine and at least one fungicide for controlling, treating and/or preventing at least one fungal plant pathogen and/or fungal disease in a plant. In an embodiment, the at least one fungicide is present in an amount needed to control, treat and/or prevent the at least one fungal plant pathogen and/or fungal disease in the plant in the presence of glycine betaine. More particularly, the amount of the at least one fungicide needed to control, treat and/or prevent the at least one fungal plant pathogen and/or fungal disease in the plant is less than an amount of the at least one fungicide needed to control treat and/or prevent the at least one fungal plant pathogen and/or fungal disease in the plant in the absence of glycine betaine. The amount of the at least one fungicide in the composition may be at least about 5%, at least about 10%, at least about 20%, at least about 30%, at least about 40%, or at least about 50%, about 60%, at least about 70%, at least about 80%, at least about 90%, or at least about 95% less than the amount of the at least one fungicide needed to control, treat and/or prevent the at least one fungal plant pathogen and/or fungal disease in the plant in the absence of glycine betaine.

The present disclosure relates additionally to a method of formulating a composition comprising glycine betaine and at least one fungicide for controlling, treating and/or preventing at least one fungal plant pathogen and/or fungal disease in a plant, the method comprising:
preparing a composition comprising glycine betaine and an amount of the at least one fungicide needed to control treat and/or prevent the at least one fungal plant pathogen and/or fungal disease in the plant in the presence of glycine betaine,
wherein the amount of the at least one fungicide needed to control treat and/or prevent the at least one fungal plant pathogen and/or fungal disease in the plant has been determined to be less than the amount of the at least one fungicide needed to control treat and/or prevent the at least one fungal plant pathogen and/or fungal disease in the plant in the absence of glycine betaine.

In an embodiment, the method further comprises:
determining an amount of the at least one fungicide needed to control, treat and/or prevent the at least one fungal plant pathogen and/or fungal disease in the plant in the absence of glycine betaine;
determining an amount of the at least one fungicide needed to control, treat and/or prevent the at least one fungal plant pathogen and/or fungal disease in the plant in the presence of glycine betaine; and/or
comparing the amount of the at least one fungicide needed to control, treat and/or prevent the at least one fungal plant pathogen and/or fungal disease in the plant in the absence of glycine betaine to the amount of the at least one fungicide needed to control treat and/or prevent the at least one fungal plant pathogen and/or fungal disease in the plant in the presence of glycine betaine.

In a further aspect, the present disclosure concerns a method for reducing the amount of a fungicide applied to a plant while maintaining a similar fungicidal effect comprising applying to a plant, soil or the vicinity of the plant a combination of fungicide with an effective amount of glycine betaine, so that the amount of fungicide required for controlling fungal plant pathogens is reduced to from about 10% to about 90% of a recommended dose for the fungicide, wherein the effective amount of glycine betaine is the amount required to achieve a similar fungicidal effect as the recommended dose of the fungicide in the absence of glycine betaine.

In an embodiment of the above described uses, methods and compositions, the fungal plant pathogen is Fusarium, Microdochium, Mycosphaerella, Puccinia, Septoria, Phaeosphaeria, Tapesia, Gaeumannomyces, Cochliobolus, Stagonospora or a combination thereof. In a further embodiment, the fungal plant pathogen is Fusarium spp., optionally wherein the fungal plant pathogen is Fusarium graminearum, Septoria tritici or Stagonospora nodorum.

In another embodiment, the plant is a monocot. In yet another embodiment, the plant belongs to the family Poaceae and can be, for example, Triticum spp. or a Hordeum spp. More particularly, the plant can be a Triticum spp. such as Triticum aestivum, Triticum aethiopicum, Triticum araraticum, Triticum boeoticum, Triticum carthlicum, Triticum cornpactum, Triticum dicoccoides, Triticum dicoccon, Triticum durum, Triticum ispahanicum, Triticum karamyschevii, Triticum macha, Triticum militinae, Triticum monococcum, Triticum polonicum, Triticum spelta, Triticum sphaerococcum, Triticum timopheevii, Triticum turanicum, Triticum turgidum, Triticum urartu, Triticum vavilovii, or Triticum zhukovskyi. In an embodiment, the plant is Triticum aestivum. Alternatively, the plant can be Hordeum spp. plant and more particularly a Hordeum vulgare L.

In an embodiment, the glycine betaine is applied to the plant, soil or the vicinity of the plant at a rate of about 0.1 to 20 kg, about 0.5 to 15 kg, about 0.5 to 10 kg or about 0.5 to 5 kg per hectare. In still another embodiment, the glycine betaine is applied to the plant, soil or the vicinity of the plant at a rate of about 0.5 kg per hectare. In yet another embodiment, the fungicide and the glycine betaine are applied simultaneously or sequentially. Preferably the fungicide and the glycine betaine are applied simultaneously. In a further embodiment, the fungicide is a systemic fungicide. In yet another embodiment, the systemic fungicide belongs to the class of the acylalanines, benzimidazoles, oxanthiins, organophosphates, pyrimidines, triazoles, strobilurins, triazolinthiones, succinate dehydrogenase inhibitor (SDHI) fungicides, piperidines, sulphur fungicides or morpholine analogue fungicides and can be, for example, metalaxyl, benomyl, carbendazim, thiabandazole, thiophanate methyl, carboxin, oxycarboxyn, fosetyl-Al, dimethirimol, ethirimol, bupirimate, fenarimol, cyprodinil, nuarimol, triadimefon, bitertanol, difenoconazole, propiconazole, myclobutanil, cyproconazole, tebuconazole, azoxystrobin, trifloxystrobin, kresoxim methyl, prothioconazole, benzovindiflupyr, bixafen, boscalid, carboxin, fluaxapyroxad, fluopyram, isopyrazam, penthiopyrad, sedaxane, fenpropimorph, fenpropidin, prochloraze, bromuconazole, epoxiconazole, metconazole, pyraclostrobin, dimoxystrobin or amorolfine. In yet another embodiment, the systemic fungicide belongs to the class of the pyrimidines, triazoles, strobilurins, triazolinthiones, succinate dehydrogenase inhibitor (SDHI) fungicides, piperidines, sulphur fungicides or morpholine analogue fungicides and can be, for example, tebuconazole, prothioconazole, bixafen, trifloxystrobin, cyproconazole, cyprodinil, fenpropidin, propiconazole, chlorothalonil or benzovindiflupyr. In yet another embodiment, examples of combinations of fungicides contemplated by the present disclosure comprise: (a) tebuconazole, prothioconazole, and bixafen; (b) trifloxystrobin; (c) cyproconazole and chlorothalonil; (d) cyprodinil; (e) fenpropidin and propiconazole; (f) benzovindiflupyr; or (g) trifloxystrobin and prothioconazole. In still another embodiment, the amount of fungicide required for controlling harmful fungi is reduced by at least 25%, 30%, 35%, 40%, 45%, 50% or 60% of the recommended dose.

In an additional aspect, the present disclosure concerns a composition comprising a fungicide in an amount of from about 10% to about 90% of a recommended dose and an effective amount of glycine betaine wherein said composition enables the use of lower recommended doses of fungicide as compared with the dose required to achieve the same effect with the fungicide alone in the absence of glycine betaine. In an embodiment, the fungicide is a systemic fungicide and belongs to the class of acylalanines, benzimidazoles, oxanthiins, organophosphates, pyrimidines, triazoles, strobilurins, triazolinthiones, succinate dehydrogenase inhibitor (SDHI) fungicides, piperidines, sulphur fungicides or morpholine analogue fungicides and can be, for example, metalaxyl, benomyl, carbendazim, thiabandazole, thiophanate methyl, carboxin, oxycarboxyn, fosetyl-Al, dimethirimol, ethirimol, bupirimate, fenarimol, cyprodinil, nuarimol, triadimefon, bitertanol, difenoconazole, propiconazole, myclobutanil, cyproconazole, tebuconazole, azoxystrobin, trifloxystrobin, kresoxim methyl, prothioconazole, benzovindiflupyr, bixafen, boscalid, carboxin, fluaxapyroxad, fluopyram, isopyrazam, penthiopyrad, sedaxane, fenpropimorph, fenpropidin, prochloraze, bromuconazole, epoxiconazole, metconazole, pyraclostrobin, dimoxystrobin or amorolfine. In still another embodiment, the systemic fungicide belongs to the class of pyrimidines, triazoles, strobilurins, triazolinthiones, succinate dehydrogenase inhibitor (SDHI) fungicides, piperidines, sulphur fungicides or morpholine analogue fungicides and can be, for example, tebuconazole, prothioconazole, bixafen, trifloxystrobin, cyproconazole, cyprodinil, fenpropidin, propiconazole, chlorothalonil or benzovindiflupyr. In yet another embodiment, the fungicide is in an amount of at least 40%, 45%, 50%, 55%, 60%, 65%, 70% or 75% of the recommended dose. The above composition may thus comprise the fungicide in an amount of at least 40%, 45%, 50%, 55%, 60%, 65%, 70% or 75% of the recommended dose.

In an embodiment of the above described uses, methods and compositions, the amount of the fungicide is reduced by from 5% to 95%. More particularly, the amount of the fungicide is reduced by at least about 5%, at least about 10%, at least about 20%, at least about 30%, at least about 40%, or at least about 50%, about 60%, at least about 70%, at least about 80%, at least about 90%, or at least about 95%.

The present disclosure also relates to embodiments of above described uses and methods which comprise sequentially applying to the plant, soil or the vicinity of the plant a first combination of at least one fungicide and glycine betaine and a second combination of at least one fungicide and glycine betaine, wherein said second combination comprises at least one fungicide not present in said first combination. Such uses and methods may further comprise applying one or more additional combinations of at least one fungicide and glycine betaine, wherein a said additional combination comprises at least one fungicide not present in a previous combination.

The present disclosure further relates to embodiments of above described uses and methods which comprise applying at least one fungicide and glycine betaine at a second node stage of said plant, applying at least one fungicide and glycine betaine at a final stage of leaf pointing or spreading of said plant and/or applying at least one fungicide and glycine betaine between heading and flowering of said plant.

### FIGURES

Having thus generally described the nature of the invention, reference will now be made to the accompanying drawings, showing by way of illustration, a preferred embodiment thereof, and in which:

FIG. 1 shows the influence of the treatments (fungicide(s) only vs fungicide(s) in combination with glycine betaine) on yield of the winter wheat.

FIG. 2 shows the influence of the treatments (fungicide(s) only vs fungicide(s) in combination with glycine betaine) on yield of the winter wheat.

FIG. 3 shows the influence of the treatments (fungicide(s) only vs fungicide(s) in combination with glycine betaine) on yield of the winter wheat.

FIG. 4 shows the influence of the treatments (fungicide(s) only vs fungicide(s) in combination with glycine betaine) on yield of the winter barley.

### DETAILED DESCRIPTION

It has been unexpectedly discovered that a specific combination of fungicide(s) and glycine betaine enables the use of relative lower amounts of fungicides, particularly as compared with the amounts required to achieve the same effect with a fungicide alone. This feature is particularly advantageous since (i) it renders the use of such a combination relatively cost-efficient; and (ii) any adverse side effects induced by the use of fungicides are substantially reduced.

According to the present disclosure, there is provided a method for reducing the amount of a fungicides, as for example synthetic fungicides, required for controlling harmful fungi in a plant or in the environment in which this plant is grown, the method comprising applying to a plant or said environment a combination of fungicides with an effective amount of glycine betaine, so that the amount of fungicides is, for example, two times smaller and may be many fold more than the amount required to achieve the same control in the absence of said combination. In other words, the use of glycine betaine in combination with fungicides makes it possible to reduce by, but not limited to, two the dose of fungicides while preserving an equivalent biological or fungicidal effect. Clearly, this reduction in the amount of fungicides is of particular importance in order to decrease any detrimental environmental effects.

The present disclosure also provides a combination of components for reducing the amount of fungicides required for controlling harmful fungi in a plant or in the environment in which this plant is grown wherein said reduced dose of fungicides and glycine betaine are present in a form that can be delivered simultaneously, sequentially or separately from each to a soil environment of a plant. By the term “combination” as used herein, the term means two or more substances in proximity to one another and/or used together, regardless of whether a carrier is included. The composition of fungicides and glycine betaine may be considered a combination.

In another embodiment, the present disclosure provides a composition comprising fungicides and glycine betaine wherein the amount of fungicides is lower, particularly as compared with the amounts required to achieve the same effect with a fungicide alone.

As used herein, the term “fungicide” refers to fungicides which do not originate from a biological source, but are produced by methods of synthetic chemistry. These are also termed “synthetic fungicides”, “conventional fungicides” or “chemical fungicides”.

The term “vicinity” as used herein means in close proximity, or directly next to and/or directly on (e.g., in physical contact with) a target plant or a seed.

According to the invention, it is possible to treat and protect all plants including parts of plants against harmful fungi. Parts of plants (such as foliage and roots) or seeds, or alternatively the soil or substrate in which the plants are growing or to be grown or in which the seeds have been or are to be sown may be treated.

The fungicidal combination of the present disclosure may be used for the protection of beneficial crops against harmful fungi. Examples of plants include, but are not limited to, cereals (such as wheat, barley, oat, rye, triticale), maize, rice, leguminous plants (such as alfalfa, clover, sainfoin), forage crop (such as ryegrass, fescues, cocksfoot, festulolium, vetch, forage turnips, forage radishes), oil- and protein-rich plants (such as soybeans, colza, peas, fava beans, white lupin, sunflower), vegetable crops, fruit trees, viticulture and ornamental crops (such as flower production, turfgrass, nurseries).

In an embodiment, the plant is a monocot. In another embodiment, the plant belongs to the family Poaceae and can be, for example, Triticum spp. or a Hordeum spp. More particularly, the plant can be a Triticum spp. selected from the group consisting of Triticum aestivum, Triticum aethiopicum, Triticum araraticum, Triticum boeoticum, Triticum carthlicum, Triticum cornpactum, Triticum dicoccoides, Triticum dicoccon, Triticum durum, Triticum ispahanicum, Triticum karamyschevii, Triticum macha, Triticum militinae, Triticum monococcum, Triticum polonicum, Triticum spelta, Triticum sphaerococcum, Triticum timopheevii, Triticum turanicum, Triticum turgidum, Triticum urartu, Triticum vavilovii, and Triticum zhukovskyi. In an embodiment, the plant is Triticum aestivum. Alternatively, the plant can be Hordeum spp. plant and more particularly a Hordeum vulgare L.

More particularly, the fungicidal combination of the present disclosure can also be implemented for the treatment of aerial plant parts, such as trunks, stems, leaves, flowers and fruits.

Non-limiting examples of diseases or fungal pathogens that can affect these plants and may be processed by the method according to the present disclosure are as follows:

genera Verticillium, Alternaria (e.g. A. solani), Fusarium (e.g. F. culmorum, F. graminearum, F. culmorum, F. graminearum, F. oxysporum, F. roseum), Microdochium (e.g. M. nivale) Magnaporthe, Monilia (e.g. M. fructigenae, M. laxa), Penicillium, Aspergillus, Botrytis (e.g. B. cinerea), Eutypa, Phaeomoniella, Phaeoacremonium, Phomopsis, Cercospora, Mycosphaerella, Bipolaris, Sclerotinia, Pythium, Phytophthora (e.g. P. infestans, P. fragariae, P. cactorum), Rhizoctonia (e.g. R. solani, R. cerealis), Puccinia (rusts; e.g. P. striiformis, P. recondite, P. hordei, P. triticina, P. tritici-duri), Leveillula, Microsphaera (e.g. M. vaccinia), Podosphaera, Odium, Sphaerotheca, Peronospora, Cercospora, Erysiphe, Uncinula, Phomopsis (e.g. P. viticola, P. rachis, P. vaccinii), Monilinia (e.g. M. vacinii-cormbosi, M. fructicola), Phragmidium (e.g. yellow rust), Drepanopeziza sp. (e.g. anthracnose), Kuehneola (e.g. cane and leaf rust), Sphaerulina (e.g. orange rust), Arthuriomyces (e.g. powdery mildew), Mycosphaerella sp. (leaf spot; e.g. M. pinodes, M. graminicola), Dendrophoma (e.g. D. obscurans), Diplocarpon (e.g. D. earliana), Godronia (e.g. G. cassandrac), Exobasidium (e.g. E. vaccinii), Gymnosporangium (e.g. apple rust), Leucostoma (e.g. L. cincta or L. persoonii), Apiosporina (e.g. A. morbosa), Sclerotium (e.g. S. rolfsii), Septoria sp. (e.g. S. tritici, S. nodorum, S. passerinii), Phaeosphaeria (e.g. P. nodorum), Tapesia (e.g. T. yallundae, T. acuiformis), Gaeumannomyces (e.g. G. graminis), Erysiphe (e.g. E. graminis, E. cichoracearum, E. beticola), Drechslera (e.g. D. triticirepentis), Pyrenophora (e.g. P. teres) Cochliobolus (e.g. C. sativus anamorphe: Bipolaris sorokiniana), Rhynchosporium (e.g. R. secalis), Ascochyta (e.g. A. pisi), Peronospora sp (e.g. P. pisi), Rhizopus sp, Trichoderma sp, Aspergillus sp (e.g. A. paraciticus), Magnaporthe (e.g. M. grisea), Pythium sp. (e.g. P. ultimatum), Sphaerotheca sp. (e.g. S. fuliginea and S. macularis), Leveillula (e.g. L. taurica), Cladosporium, Colletotrichum (e.g. C. acutatum), Venturia (V. inaequalis), Podosphaera (e.g. P. leucotricha), Uncinula (e.g. U. necator), Guignardia (e.g. G. bidwellii), Plasmopara (P. viticola), Ramularia (R. beticola), Cercospora (e.g. C. beticola), Stagonospora (S. nodorum), Drechslera teres f. maculata, Ramularia collo cygni, Ophiocladium horde or Blumeria graminis. More particularly, the fungal plant pathogens that can affect these plants and may be processed by the method according to the present disclosure are from the following genera: Fusarium, Microdochium, Mycosphaerella, Puccinia, Septoria, Phaeosphaeria, Tapesia, Gaeumannomyces, Cochliobolus or Stagonospora,

The compositions may be applied in various combinations of fungicides and glycine betaine. For example, they may be applied simultaneously as a single “ready-mix” form, or as a freshly made mixture, i.e. in a combined spray mixture composed from separate formulations of the fungicides and glycine betaine, e.g. a “tank-mix” form. Thus, to be used in combination, it is not necessary that the fungicides and glycine betaine, be applied in a physically combined form, or even at the same time, i.e. the compounds may be applied in a separately and/or sequentially application, provided that the application of the second compound occurs within a reasonable period of time from the application of the first compound. The combination effect results so long as the fungicides and glycine betaine are present at the same time, regardless of when they were applied. The order of applying the individual fungicides and glycine betaine is not essential. As used herein, the term “delivering simultaneously” means that the fungicides and the glycine betaine are delivered to a plant, roots of a plant, soil or substrate or seeds of a plant at the same time or substantially at the same time via the same mode of application. As used herein, the term “delivering separately” means that the fungicides and the glycine betaine are delivered to a plant, roots of a plant, soil or substrate or seeds of a plant at the same time or substantially at the same time via a different mode of application. As used herein, the term “delivering sequentially” means that the fungicides and the glycine betaine are delivered to a plant, roots of a plant, soil or substrate or seeds of a plant at different times, the mode of application being identical or different.

Rates of application of the composition will vary according to prevailing conditions such as targeted harmful fungi, degree of infestation, weather conditions, soil conditions, plant species to be treated, mode of application, and application time. Compositions containing the fungicides and glycine betaine may be applied in the manner which they are formulated, as discussed above. For example, they may be applied as sprays, such as water-dispersible concentrates, wettable powders, water-dispersible granules or the likes.

Glycine-betaine extracted from sugar beet is commercially available for example under the trademark of IntraCell®, Greenstim® or Bluestim® (Lallemand). Other betaine products, such as betaine monohydrate, betaine hydrochloride and raw betaine liquids, are also commercially available and they can be used for the purposes of the present disclosure.

When used in separate formulations, the glycine-betaine is usually applied in suspension at a suitable concentration. Accordingly, in an embodiment, the suspension of glycine-betaine is applied to the aerial parts of a plant, flower parts of a plant or flowers of a plant in either one or several successive treatments. The amount used varies depending on the plant variety, the phase of growth, the leaf surface and water needs. For example, at least, about 0.1 to 20 kg; about 0.5 to 15 kg; about 0.5 to 10 kg or about 0.5 to 5 kg of glycine-betaine can be used per hectare. In another embodiment, glycine-betaine is applied or delivered directly to the aerial parts of a plant, flower parts of a plant or flowers of a plant in an amount of at least about 0.1 kg, 0.2 kg, 0.3 kg, 0.4 kg, 0.5 kg, 0.6 kg, 0.7 kg, 0.8 kg, 0.9 kg, 1 kg, 2 kg, 3 kg, 4 kg, 5 kg, 6 kg, 7 kg, 8 kg, 9 kg, 10 kg, 11 kg, 12 kg, 13 kg, 14 kg, 15 kg, 16 kg, 17 kg, 18 kg, 19 kg, 19 kg or 20 kg of dry matter per hectare. The amounts given here are only suggestive and the person skilled in the art can easily determine effective concentrations that work in the manner described herein.

In the context of the present disclosure, the fungicide is a systemic fungicide. As used herein, the term “systemic fungicide” refers to a fungicide which is absorbed by the foliage and roots and translocated upward internally by the plant through the xylem. Examples, but not limited to, of systemic fungicides which are particularly suitable for use in a combination according to the present disclosure belong to the following groups: acylalanines (as, for example, metalaxyl), benzimidazoles (they include some of the systemic fungicides like benomyl, carbendazim, thiabandazole or thiophanate methyl), oxanthiins (they include primarily carboxin or oxycarboxyn), organophosphates (they include primarily fosetyl-Al), pyrimidines (they include dimethirimol, ethirimol, bupirimate, fenarimol, cyprodinil or nuarimol), triazoles (-conazoles or imidazoles—they include several systemic fungicides such as triadimefon, bitertanol, difenoconazole, propiconazole, myclobutanil, cyproconazole prochloraze, bromuconazole, epoxiconazole, metconazole or tebuconazole), strobilurins (also known as Qol fungicides, they include, for example, azoxystrobin, trifloxystrobin, pyraclostrobin, dimoxystrobin or kresoxim methyl), triazolinthiones (they include, for example, prothioconazole), succinate dehydrogenase inhibitor (SDHI) fungicides (they include, for example, benzovindiflupyr, bixafen, boscalid, carboxin, fluaxapyroxad, fluopyram, isopyrazam, penthiopyrador sedaxane), piperidines (they include, for example, fenpropidin), organochlorine (as, for example, chlorothalonil), morpholine analogue fungicides (they include, for example, fenpropimorph, fenpropidin or amorolfine), sulphur fungicide, or a combination of any thereof. Examples of combinations of fungicides contemplated by the present disclosure comprises: (a) tebuconazole, prothioconazole, and bixafen; (b) trifloxystrobin; (c) cyproconazole and chlorothalonil; (d) cyprodinil; (e) fenpropidin and propiconazole; (f) benzovindiflupyr; or (g) trifloxystrobin and prothioconazole. The present disclosure also relates to embodiments of above described uses and methods which comprise sequentially applying to the plant, soil or the vicinity of the plant a first combination of at least one fungicide and glycine betaine and a second combination of at least one fungicide and glycine betaine, wherein said second combination comprises at least one fungicide not present in said first combination. Such uses and methods may further comprise applying one or more additional combinations of at least one fungicide and glycine betaine, wherein a said additional combination comprises at least one fungicide not present in a previous combination.

The present disclosure further relates to embodiments of above described uses and methods which comprise applying at least one fungicide and glycine betaine at a second node stage of said plant, applying at least one fungicide and glycine betaine at a final stage of leaf pointing or spreading of said plant and/or applying at least one fungicide and glycine betaine between heading and flowering of said plant. A final stage of leaf pointing or spreading of said plant refers to a stage at which the final leaves of said plant point or spread, and preferably to a plant where the last leaf has pointed or spread out.

The use or method may comprise sequentially applying first and second (and optionally additional) combinations of at least one fungicide and glycine betaine at the second node stage of said plant, final stage of leaf pointing or spreading of said plant and/or between heading and flowering of said plant, wherein each said combination comprises at least one fungicide not present in a previous combination. The skilled person is able to select appropriate fungicides for use at each stage of growth of the plant based on the plant type, geographical location and prevalence of plant pathogens, based on their common general knowledge. Suitable fungicides for use at particular plant growth stages are described below and also in the Examples. A fungicide for use at a second node stage of a plant may comprise tebuconazole, metconazole, chlorothalonil, prochloraze, a sulphur fungicide, strobilurine or a combination thereof. A fungicide for use at a final stage of leaf pointing or spreading of a plant may comprise tebuconazole, metconazole, epoxiconazole, cyproconazole, fluxapyroxad, bizafen, benzovindiflupyr or a combination thereof. A fungicide for use between heading and flowering of a plant may comprise prothioconazole difenoconazole, tebuconazole, metconazole, epoxiconazole or a combination thereof. A fungicide for use between heading and flowering of a plant may comprise prothioconazole and/or difenoconazole.

According to the invention, where sequential applications of fungicides are carried out, fungicides may be applied at two or all three of the above stages in combination with glycine betaine. The present disclosure preferably provides in this embodiment a use or method according to the invention where a fungicide is applied at a second node stage of a plant (optionally a said fungicide as described above) in combination with glycine betaine, and a fungicide is applied at a final stage of leaf pointing or spreading of a plant (optionally a said fungicide as described above) in combination with glycine betaine.

The combination of the present disclosure may be obtained by combining glycine betaine with a reduced amount of fungicides as long as the fungicidal action is achieved. As used herein, the term “recommended dose” is synonym of a homologated dose or an approved dose and means the amount of formulated product of a fungicide applied as recommended by authorities. In an embodiment, the amount of fungicide applied is within a range of from about 10% to about 90% of the recommended dose, from about 15% of the recommended dose to about 85% of the recommended dose, from about 20% of the recommended dose to about 80% of the recommended dose, from about 25% of the recommended dose to about 75% of the recommended dose, from about 30% of the recommended dose to about 70% of the recommended dose or from about 40% of the recommended dose to about 60% of the recommended dose. In some embodiments, the amount of fungicide applied corresponds to at least 10% of the recommended dose, at least 15% of the recommended dose, at least 20% of the recommended dose, at least 25% of the recommended dose, at least 30% of the recommended dose, at least 35% of the recommended dose, at least 40% of recommended dose, at least 50% of the recommended dose, at least 55% of the recommended dose, at least 60% of the recommended dose, at least 65% of the recommended dose, at least 70% of the recommended dose, at least 75% of the recommended dose, at least 80% of the recommended dose, at least 85% of the recommended dose or at least 90% of the recommended dose and is selected to maintain the fungicidal properties of the combination. It is expected than even lower concentrations of fungicides may be effectively combined with glycine betaine while maintaining the fungicidally effective properties of the combination.

The application may be performed for example by spraying together with some other spraying of fertilizers or pesticides, if desired. The solution of glycine-betaine may also contain wetting agents and/or surfactants which assist in permeating the aerial parts of a plant, flower parts of a plant or flowers of a plant. Glycine-betaine utilized according to the present disclosure is transported to the plant cells, actively regulates the osmotic balance of the cells and also participates in other processes of cell metabolism. A cell treated with glycine-betaine is more viable even when subjected to exogenous stress factors.

The composition of the present disclosure may include a suitable carrier and/or diluent and may be provided in a form of a solid, a powder, a solution, dispersion, a suspension, a paste, an aerosol or a spray, wherein the active ingredients of the present disclosure (namely, the fungicides and the glycine betaine) are formulated in a manner which suits the specific application. Non-limiting examples of suitable, formulations are: emulsion concentrates, suspension concentrates, water dispersible granule and wettable powders. The carrier or diluent, which is an agriculturally acceptable carrier or diluent, may be any one or more of a number of carriers that confer a variety of properties, such as increased stability, wettability, dispersability, etc. Suitable carriers may include, but are not limited to, water or other aqueous solutions, slurries, solids (e.g., peat, wheat, bran, vermiculite, pasteurized soil, etc) or dry powders. The composition or formulation may include additional additives including, but not limited to, buffering agents, surfactants, adjuvants, or coating agents.

The word “comprising” in the claims may be replaced by “consisting essentially of” or with “consisting of,” according to standard practice in patent law.

The following example serves to further describe and define the invention, and is not intended to limit the invention in any way.

### Example 1

Four field trials were conducted in the region of Hauts-de-France to evaluate the efficacy of glycine betaine in combination with fungicides in controlling fungal infections in plants. It was observed that the combination of the present disclosure was able to decrease the amount of the fungicides, while retaining the overall fungicidal effectiveness.

During the crop growing season, different fungicides are sequentially used in the art to control a number of different diseases. For example, at early stage (second node), fungicides, as for example CITADELLE (chlorothalonil and cyproconazole), are applied to control rust, powdery mildew, Septoria (S. tritici) and also Stagonospora nodorum. Further, when the last leaf points or spreads out, KAROSSE (tebuconazole, prothioconazole and bixafen), for example, can be used to control Septoria. Finally, between heading and flowering, the use of fungicides (for example, prothioconazole) is carried out mainly to control different species of Fusarium spp, or Microdochium spp.

The treatments used in the four different trials are described in Tables 1 to 4.

TABLE 1
Trial 1 performed on winter wheat (variety Bergamo)

| | |
|---|---|
| Treatment 1 | KAROSSE ® XPRO¹ 0.7² + TWIST 500 SC¹ 0.14² |
| Treatment 2 | KAROSSE ® XPRO 0.35² + TWIST 500 SC 0.07² + |
| | INTRACELL 0.5 kg/ha³ |
| Control | Non treated control |

¹commercially available from Bayer
²This number refers to the Treatment Frequency Indicator (TFI) which is equal to the sum, for the various applications, of the ratio of the applied fungicide dose to the national recommended dose.
³This refers to the dose rate per treatment.

In this assay, the concentration of the fungicide KAROSSE® XPRO (tebuconazole 100 g/L, prothioconazole 100 g/L and bixafen 75 g/L) and the fungicide TWIST 500 SC (trifloxystrobin 500 g/L) was reduced by 50%.

TABLE 2
Trial 2 performed on winter wheat (variety Bergamo)

| | |
|---|---|
| Treatment 1 | CITADELLE¹ 1.5 |
| Treatment 2 | CITADELLE 1 + INTRACELL 0.5 kg/ha |
| Control | Non treated control |

¹commercially available from Syngenta

In this assay, the concentration of the fungicide CITADELLE (chlorothalonil 375 g/L and cyproconazole 40 g/L) was reduced by 34%.

TABLE 3
Trial 3 performed on winter wheat (variety Bergamo)

| | |
|---|---|
| Treatment 1 | KAROSSE ® XPRO 0.7 |
| Treatment 2 | KAROSSE ® XPRO 0.5 + INTRACELL 0.5 kg/ha |
| Control | Non treated control |

In this assay, the concentration of the fungicide KAROSSE® XPRO (tebuconazole 100 g/L, prothioconazole 100 g/L and bixafen 75 g/L) was reduced by 29%.

TABLE 4
Trial 4 performed on winter barley

| | |
|---|---|
| Treatment 1 | 1^{st} application: KAYAK¹ 1 + MELTOP¹ 0.5 |
| | 2^{nd} application: ELATUS¹ PLUS 0.6 + CITADELLE¹ 1.2 |
| Treatment 2 | 1^{st} application: KAYAK 1 + MELTOP 0.5 |
| | 2^{nd} application: ELATUS PLUS 0.6 + CITADELLE 1.2 |
| | 3^{rd} application: KAPULCO² 0.6 |
| Treatment 3 | 1^{st} application: KAYAK 0.75 + MELTOP 0.5 + |
| | INTRACELL 0.5 |
| | 2^{nd} application: ELATUS PLUS 0.45 + CITADELLE 0.9 + |
| | INTRACELL 0.5 kg/ha |
| Treatment 4 | 1^{st} application: KAYAK 1 + MELTOP 0.5 + |
| | INTRACELL 0.5 |
| | 2^{nd} application: ELATUS PLUS 0.6 + CITADELLE 1.2 + |
| | INTRACELL 0.5 kg/ha |
| Control | Non treated control |

¹commercially available from Syngenta
²commercially available from Bayer

In this assay, the concentration of the fungicides KAYAK (cyprodinil 300 g/L), ELATUS PLUS (benzovindiflupyr 100 g/L) and CITADELLE (chlorothalonil 375 g/L and cyproconazole 40 g/L) was reduced by 25%. The concentrations of MELTOP (fenpropidine 500 g/L and propiconazole 125 g/L) and KAPULCO (prothioconazole 175 g/L and trifloxystrobin 88 g/L) did not vary during the assay.

Experimental design was in randomized complete blocks with 3 or 4 replicates. The seeding rate of wheat and barley seeds is 275 gr/m² and 250 gr/m², respectively. All applications were done using an “Expert” sprayer controlled at a pressure of 2 bar and a spray solution volume of 150 I/ha. The spray solution was a mixture of 97% pure glycine betaine (Intracell®, Lallemand) and fungicide(s). The effect of the different tested combinations was measured on plant yield. Statistical comparisons were made by analysis of variance (one-way ANOVA) followed by a Tukey-Kramer post-test. P-values of <0.05 indicated statistical significance.

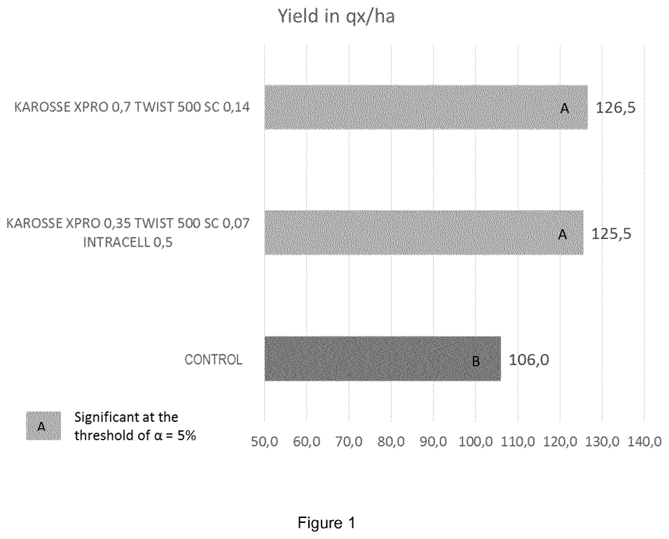

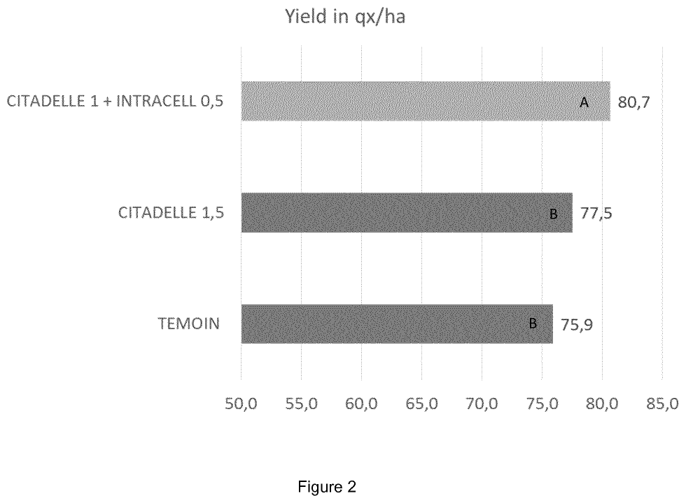

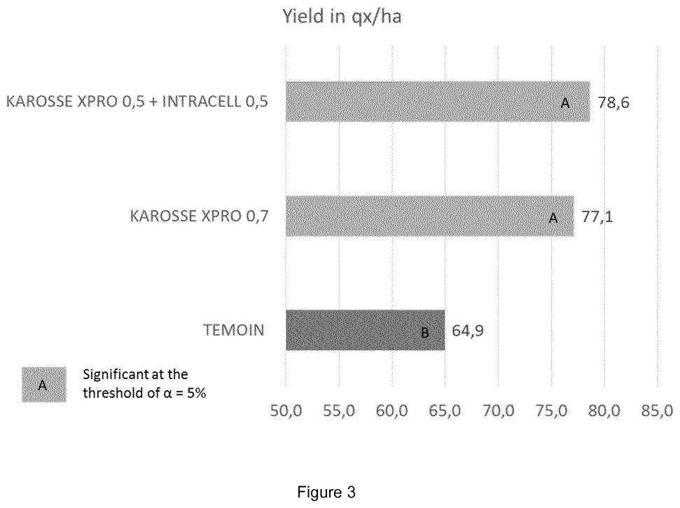

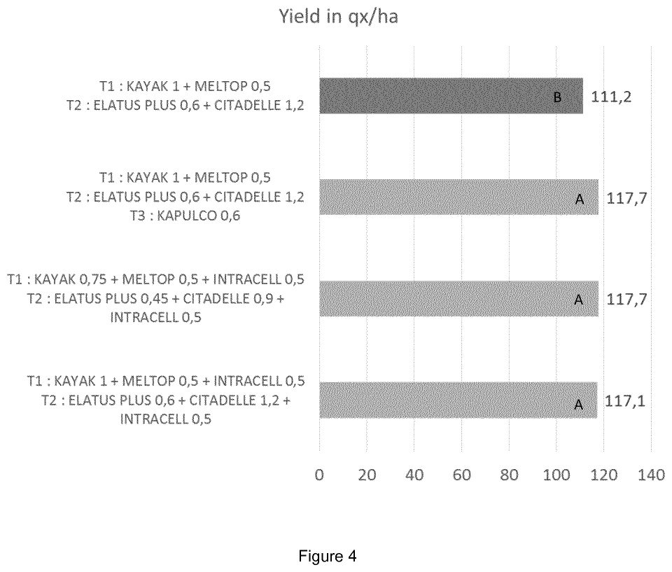

As shown in FIGS. 1 to 4, it was found that glycine betaine in combination with reduced doses of fungicides resulted in the same level of protection and similar mean yield as treatments with the recommended full dose of fungicides. These combined treatments with fungicides and glycine betaine reduce the need of traditional fungicides. Furthermore, as shown in FIG. 4, mean yield of winter barley treated with a combination of glycine betaine and fungicides (conventional dose (Treatment 4) and reduced doses of fungicides (Treatment 3)) was equivalent to the mean yield of winter barley treated with three different applications of fungicides (Treatment 2).

While the invention has been described in connection with specific embodiments thereof, it will be understood that the scope of the claims should not be limited by the preferred embodiments set forth in the examples, but should be given the broadest interpretation consistent with the description as a whole.

Further aspects of the invention:
1. A method for reducing the amount of a fungicide applied to a plant while maintaining a similar fungicidal effect comprising applying to a plant, soil or the vicinity of the plant a combination of fungicide with an effective amount of glycine betaine, so that the amount of fungicide required for controlling fungal plant pathogens is reduced within a range from about 10% to about 90% of a recommended dose which recommended dose is the amount required to achieve the same control if the fungicide is used alone in the absence of glycine betaine.
2. The method of paragraph 1, wherein the glycine betaine is applied to the plant, soil or the vicinity of the plant at a rate of about 0.1 to 20 kg, about 0.5 to 15 kg, about 0.5 to 10 kg or about 0.5 to 5 kg per hectare.
3. The method of paragraph 2, wherein the glycine betaine is applied to the plant, soil or the vicinity of the plant at a rate of about 0.5 kg per hectare.
4. The method of any one of paragraphs 1 to 3, wherein the fungicide and the glycine betaine are applied simultaneously or sequentially; preferably the fungicide and the glycine betaine are applied simultaneously.
5. The method of any one of paragraphs 1 to 4, wherein the fungicide is a systemic fungicide.
6. The method of paragraph 5, wherein the systemic fungicide belongs to the class of acylalanines, benzimidazoles, oxanthiins, organophosphates, pyrimidines, triazoles, strobilurins, triazolinthiones, succinate dehydrogenase inhibitor (SDHI) fungicides, piperidines, or morpholine analogue fungicides.
7. The method of paragraph 6, wherein the systemic fungicide is metalaxyl, benomyl, carbendazim, thiabandazole, thiophanate methyl, carboxin, oxycarboxyn, fosetyl-Al, dimethirimol, ethirimol, bupirimate, fenarimol, cyprodinil, nuarimol, triadimefon, bitertanol, difenoconazole, propiconazole, myclobutanil, cyproconazole, tebuconazole, azoxystrobin, trifloxystrobin, kresoxim methyl, prothioconazole, benzovindiflupyr, bixafen, boscalid, carboxin, fluaxapyroxad, fluopyram, isopyrazam, penthiopyrad, sedaxane, fenpropidin, fenpropimorph, fenpropidin or amorolfine.
8. The method of paragraph 7, wherein the systemic fungicide belongs to the class of pyrimidines, triazoles, strobilurins, triazolinthiones, succinate dehydrogenase inhibitor (SDHI) fungicides, piperidines or morpholine analogue fungicides.
9. The method of paragraph 8, wherein the systemic fungicide is tebuconazole, prothioconazole, bixafen, trifloxystrobin, cyproconazole, cyprodinil, fenpropidin, propiconazole or benzovindiflupyr.
10. The method of any one of paragraphs 1 to 9, wherein the amount of fungicide required for controlling harmful fungi is reduced by at least 25%, 30%, 35%, 40%, 45%, 50% or 60% of the recommended dose.
11. A composition comprising a fungicide in an amount of from about 10% to about 90% of a recommended dose and an effective amount of glycine betaine wherein said composition enables the use of lower recommended doses of fungicide as compared with the dose required to achieve the same effect with the fungicide alone in the absence of glycine betaine.
12. The composition of paragraph 11, wherein the fungicide is a systemic fungicide.
13. The composition of paragraph 12, wherein the systemic fungicide belongs to the class of acylalanines, benzimidazoles, oxanthiins, organophosphates, pyrimidines, triazoles, strobilurins, triazolinthiones, succinate dehydrogenase inhibitor (SDHI) fungicides, piperidines, or morpholine analogue fungicides.
14. The composition of paragraph 13, wherein the systemic fungicide is metalaxyl, benomyl, carbendazim, thiabandazole, thiophanate methyl, carboxin, oxycarboxyn, fosetyl-Al, dimethirimol, ethirimol, bupirimate, fenarimol, cyprodinil, nuarimol, triadimefon, bitertanol, difenoconazole, propiconazole, myclobutanil, cyproconazole, tebuconazole, azoxystrobin, trifloxystrobin, kresoxim methyl, prothioconazole, benzovindiflupyr, bixafen, boscalid, carboxin, fluaxapyroxad, fluopyram, isopyrazam, penthiopyrad, sedaxane, fenpropidin, fenpropimorph, fenpropidin or amorolfine.
15. The composition of paragraph 12, wherein the systemic fungicide belongs to the class of pyrimidines, triazoles, strobilurins, triazolinthiones, succinate dehydrogenase inhibitor (SDHI) fungicides, piperidines or morpholine analogue fungicides.
16. The composition of paragraph 14, wherein the systemic fungicide is tebuconazole, prothioconazole, bixafen, trifloxystrobin, cyproconazole, cyprodinil, fenpropidin, propiconazole or benzovindiflupyr.
17. The composition of any one of paragraphs 11 to 16, wherein the fungicide is in an amount of at least 40%, 45%, 50%, 55%, 60%, 65%, 70% or 75% of the recommended dose.

1. Use of glycine betaine and at least one fungicide for controlling, treating and/or preventing at least one fungal plant pathogen and/or fungal disease in a plant.

2. Use of glycine betaine for reducing the amount of at least one fungicide applied to a plant to control, treat and/or prevent at least one fungal plant pathogen and/or fungal disease in the plant.

3. A method for controlling, treating and/or preventing at least one fungal plant pathogen and/or fungal disease in a plant comprising
applying to the plant, soil or the vicinity of the plant a combination of glycine betaine and at least one fungicide.

4. A method for reducing the amount of at least one fungicide applied to a plant to control, treat and/or prevent at least one fungal plant pathogen and/or fungal disease in the plant comprising
applying to the plant, soil or the vicinity of the plant a combination of glycine betaine and the at least one fungicide.

5. The use of claim 1 or 2 or the method of claim 3 or 4, wherein the at least one fungicide is used or applied in an amount that is less than an amount of the at least one fungicide needed to control, treat and/or prevent the at least one fungal plant pathogen and/or fungal disease in the plant in the absence of glycine betaine.

6. A method for reducing the amount of at least one fungicide applied to a plant while maintaining fungicidal effect, the method comprising:
applying to the plant, soil or the vicinity of the plant a combination of an amount of glycine betaine and an amount of at least one fungicide;
wherein the amount of the at least one fungicide is less than the recommended dose for the at least one fungicide,
wherein the amount of glycine betaine and the amount of the at least one fungicide applied to the plant achieve substantially the same fungicidal effect as would be achieved by application of the recommended dose of the at least one fungicide alone.

7. The method of claim 6, wherein the reduction in amount of the at least one fungicide relative to the recommended dose is replaced by the amount of glycine betaine.

8. The method of claim 7, wherein the amount of the least one fungicide replaced by the amount of glycine betaine is from about 5 wt % to about 95 wt %, from about 20 wt % to about 80 wt %, from about 35 wt % to about 65 wt %, from about 45 wt % to about 55 wt %, or about 50 wt %, of the recommended dose of the at least one fungicide.

9. The method of claim 6, wherein the amount of the at least one fungicide is at least about 5%, at least about 10%, at least about 20%, at least about 30%, at least about 40%, or at least about 50%, about 60%, at least about 70%, at least about 80%, at least about 90%, or at least about 95% less than the recommended dose for the at least one fungicide.

10. A method for reducing the amount of at least one fungicide applied to a plant while maintaining fungicidal effect, the method comprising:
applying to the plant, soil or the vicinity of the plant a combination of glycine betaine and the at least one fungicide;
wherein the at least one fungicide is applied to the plant in an amount less than the recommended dose for the at least one fungicide, and wherein the glycine betaine replaces from about 5 wt % to about 95 wt % of the recommended dose of the at least one fungicide.

11. The method of any one of claims 6-10, which achieves at least about 75%, at least about 80%, at least about 85%, at least about 90%, at least about 95%, or at least about 100% of the fungicidal effect as would be achieved by application of the recommended dose of the at least one fungicide alone.

12. The use of any one of claims 1, 2 and 5 or the method of any one of claim 3-11, wherein the glycine betaine is applied to the plant, soil or the vicinity of the plant at a dose of about 0.1 to 20 kg, about 0.5 to 15 kg, about 0.5 to 10 kg or about 0.5 to 5 kg per hectare.

13. The use or method of claim 12, wherein the glycine betaine is applied to the plant, soil or the vicinity of the plant at a dose of about 0.5 kg per hectare.

14. The use of any one of claims 1, 2, 5 and 12-13 or the method of any one of claims 3-13, wherein the glycine betaine and the at least one fungicide are applied to the plant simultaneously or sequentially.

15. A composition comprising glycine betaine and at least one fungicide for controlling, treating and/or preventing at least one fungal plant pathogen and/or fungal disease in a plant.

16. The composition of claim 15, wherein the at least one fungicide is present in an amount needed to control, treat and/or prevent the at least one fungal plant pathogen and/or fungal disease in the plant in the presence of glycine betaine.

17. The composition of claim 16, wherein the amount of the at least one fungicide needed to control treat and/or prevent the at least one fungal plant pathogen and/or fungal disease in the plant is less than an amount of the at least one fungicide needed to control, treat and/or prevent the at least one fungal plant pathogen and/or fungal disease in the plant in the absence of glycine betaine.

18. A method of formulating a composition comprising glycine betaine and at least one fungicide for controlling, treating and/or preventing at least one fungal plant pathogen and/or fungal disease in a plant, the method comprising:
preparing a composition comprising glycine betaine and an amount of the at least one fungicide needed to control treat and/or prevent the at least one fungal plant pathogen and/or fungal disease in the plant in the presence of glycine betaine,
wherein the amount of the at least one fungicide needed to control treat and/or prevent the at least one fungal plant pathogen and/or fungal disease in the plant has been determined to be less than the amount of the at least one fungicide needed to control treat and/or prevent the at least one fungal plant pathogen and/or fungal disease in the plant in the absence of glycine betaine.

19. The method of claim 18, further comprising:
determining an amount of the at least one fungicide needed to control, treat and/or prevent the at least one fungal plant pathogen and/or fungal disease in the plant in the absence of glycine betaine;
determining an amount of the at least one fungicide needed to control, treat and/or prevent the at least one fungal plant pathogen and/or fungal disease in the plant in the presence of glycine betaine; and/or
comparing the amount of the at least one fungicide needed to control, treat and/or prevent the at least one fungal plant pathogen and/or fungal disease in the plant in the absence of glycine betaine to the amount of the at least one fungicide needed to control treat and/or prevent the at least one fungal plant pathogen and/or fungal disease in the plant in the presence of glycine betaine.

20. The use of any one of claims 1, 2, 5 and 12-14, the method of any one of claims 3-14 and 18-19, or the composition of any one of claims 15-17, wherein the fungal plant pathogen is Fusarium, Microdochium, Mycosphaerella, Puccinia, Septoria, Phaeosphaeria, Tapesia, Gaeumannomyces, Cochliobolus, Stagonospora or a combination thereof,

21. The use, method or composition of claim 20, wherein the fungal plant pathogen is Fusarium spp., optionally wherein the fungal plant pathogen is Fusarium graminearum, Septoria tritici or Stagonospora nodorum.

22. The use of any one of claims 1, 2, 5, 12-14 and 20-21, the method of any one of claims 3-14 and 18-21, or the composition of any one of claims 15-17 and 20-21, wherein the plant is a monocot.

23. The use, method or composition of claim 22, wherein the plant belongs to the family Poaceae.

24. The use, method or composition of claim 23, wherein the plant is a Triticum spp. or a Hordeum spp.

25. The use, method or composition of claim 24, wherein the plant is Triticum aestivum, Triticum aethiopicum, Triticum araraticum, Triticum boeoticum, Triticum carthlicum, Triticum cornpactum, Triticum dicoccoides, Triticum dicoccon, Triticum durum, Triticum ispahanicum, Triticum karamyschevii, Triticum macha, Triticum militinae, Triticum monococcum, Triticum polonicum, Triticum spelta, Triticum sphaerococcum, Triticum timopheevii, Triticum turanicum, Triticum turgidum, Triticum urartu, Triticum vavilovii, or Triticum zhukovskyi.

26. The use, method or composition of claim 25, wherein the plant is Triticum aestivum.

27. The use, method or composition of claim 26, wherein the Hordeum spp. plant is Hordeum vulgare L.

28. The use of any one of claims 1, 2, 5, 12-14 and 20-27, the method of any one of claims 3-14 and 18-27, or the composition of any one of claims 15-17 and 20-27, wherein the at least one fungicide is a systemic fungicide.

29. The use of any one of claims 1, 2, 5, 12-14 and 20-28, the method of any one of claims 3-14 and 18-28, or the composition of any one of claims 15-17 and 20-28, wherein the at least one fungicide is an acylalanine, benzimidazole, oxanthiin, organophosphate, pyrimidine, triazole, strobilurin, triazolinthione, succinate dehydrogenase inhibitor (SDHI) fungicide, piperidine, morpholine analogue fungicide, sulphur fungicide or a combination thereof.

30. The use, method or composition of claim 29, wherein the at least one fungicide is a pyrimidine, triazole, strobilurin, triazolinthione, succinate dehydrogenase inhibitor (SDHI) fungicide, piperidine, morpholine analogue fungicide, sulphur fungicide or a combination thereof.

31. The use of any one of claims 1, 2, 5, 12-14 and 20-30, the method of any one of claims 3-14 and 18-30, or the composition of any one of claims 15-17 and 20-30, wherein the at least one fungicide is metalaxyl, benomyl, carbendazim, thiabandazole, thiophanate methyl, carboxin, oxycarboxyn, fosetyl-Al, dimethirimol, ethirimol, bupirimate, fenarimol, cyprodinil, nuarimol, triadimefon, bitertanol, difenoconazole, propiconazole, myclobutanil, cyproconazole, tebuconazole, azoxystrobin, trifloxystrobin, kresoxim methyl, prothioconazole, benzovindiflupyr, bixafen, boscalid, carboxin, fluaxapyroxad, fluopyram, isopyrazam, penthiopyrad, sedaxane, fenpropidin, fenpropimorph, amorolfine, chlorothalonil, prochloraze, bromuconazole, epoxiconazole, metconazole, pyraclostrobin, dimoxystrobin, or a combination thereof.

32. The use, method or composition of claim 31, wherein the at least one fungicide is selected from the group consisting of tebuconazole, prothioconazole, bixafen, trifloxystrobin, cyproconazole, cyprodinil, fenpropidin, propiconazole, benzovindiflupyr, chlorothalonil and combinations thereof.

33. The use, method or composition of claim 32, wherein the at least one fungicide comprises:
(a) tebuconazole, prothioconazole, and bixafen;
(b) trifloxystrobin;
(c) cyproconazole and chlorothalonil;
(d) cyprodinil;
(e) fenpropidin and propiconazole;
(f) benzovindiflupyr; or
(g) trifloxystrobin and prothioconazole.

34. A method for reducing the amount of a fungicide applied to a plant while maintaining a similar fungicidal effect comprising
applying to a plant, soil or the vicinity of the plant a combination of the fungicide with an effective amount of glycine betaine, so that the amount of the fungicide required for controlling fungal plant pathogens is reduced to from about 10% to about 90% of a recommended dose for the fungicide,
wherein the effective amount of glycine betaine is the amount required to achieve a similar fungicidal effect as the recommended dose of the fungicide in the absence of glycine betaine.

35. The method of claim 34, wherein the glycine betaine is applied to the plant, soil or the vicinity of the plant at a rate of about 0.1 to 20 kg, about 0.5 to 15 kg, about 0.5 to 10 kg or about 0.5 to 5 kg per hectare.

36. The method of claim 35, wherein the glycine betaine is applied to the plant, soil or the vicinity of the plant at a rate of about 0.5 kg per hectare.

37. The method of any one of claims 34-36, wherein the fungicide and the glycine betaine are applied simultaneously or sequentially; preferably the fungicide and the glycine betaine are applied simultaneously.

38. The method of any one of claims 34-37, wherein the fungicide is a systemic fungicide.

39. The method of claim 38, wherein the systemic fungicide belongs to the class of acylalanines, benzimidazoles, oxanthiins, organophosphates, pyrimidines, triazoles, strobilurins, triazolinthiones, succinate dehydrogenase inhibitor (SDHI) fungicides, piperidines, morpholine analogue fungicides, sulphur fungicide or a combination thereof.

40. The method of claim 39, wherein the systemic fungicide is metalaxyl, benomyl, carbendazim, thiabandazole, thiophanate methyl, carboxin, oxycarboxyn, fosetyl-Al, dimethirimol, ethirimol, bupirimate, fenarimol, cyprodinil, nuarimol, triadimefon, bitertanol, difenoconazole, propiconazole, myclobutanil, cyproconazole, tebuconazole, azoxystrobin, trifloxystrobin, kresoxim methyl, prothioconazole, benzovindiflupyr, bixafen, boscalid, carboxin, fluaxapyroxad, fluopyram, isopyrazam, penthiopyrad, sedaxane, fenpropimorph, fenpropidin, amorolfine, chlorothalonil, prochloraze, bromuconazole, epoxiconazole, metconazole, pyraclostrobin, dimoxystrobin, or a combination thereof.

41. The method of claim 40, wherein the systemic fungicide belongs to the class of pyrimidines, triazoles, strobilurins, triazolinthiones, succinate dehydrogenase inhibitor (SDHI) fungicides, piperidines morpholine analogue fungicides, sulphur fungicide or a combination thereof.

42. The method of claim 41, wherein the systemic fungicide is tebuconazole, prothioconazole, bixafen, trifloxystrobin, cyproconazole, cyprodinil, fenpropidin, propiconazole, chlorothalonil or benzovindiflupyr.

43. The method of any one of claims 34-42, wherein the amount of fungicide required for controlling harmful fungi is reduced by at least 25%, 30%, 35%, 40%, 45%, 50% or 60% of the recommended dose.

44. A composition comprising a fungicide in an amount of from about 10% to about 90% of a recommended dose and an effective amount of glycine betaine wherein said composition enables the use of lower recommended doses of fungicide as compared with the dose required to achieve the same effect with the fungicide alone in the absence of glycine betaine.

45. The composition of claim 44, wherein the fungicide is a systemic fungicide.

46. The composition of claim 45, wherein the systemic fungicide belongs to the class of acylalanines, benzimidazoles, oxanthiins, organophosphates, pyrimidines, triazoles, strobilurins, triazolinthiones, succinate dehydrogenase inhibitor (SDHI) fungicides, piperidines, morpholine analogue fungicides, sulphur fungicide or a combination thereof.

47. The composition of claim 46, wherein the systemic fungicide is metalaxyl, benomyl, carbendazim, thiabandazole, thiophanate methyl, carboxin, oxycarboxyn, fosetyl-Al, dimethirimol, ethirimol, bupirimate, fenarimol, cyprodinil, nuarimol, triadimefon, bitertanol, difenoconazole, propiconazole, myclobutanil, cyproconazole, tebuconazole, azoxystrobin, trifloxystrobin, kresoxim methyl, prothioconazole, benzovindiflupyr, bixafen, boscalid, carboxin, fluaxapyroxad, fluopyram, isopyrazam, penthiopyrad, sedaxane, fenpropimorph, fenpropidin amorolfine, chlorothalonil, prochloraze, bromuconazole, epoxiconazole, metconazole, pyraclostrobin, dimoxystrobin, or a combination thereof.

48. The composition of claim 45, wherein the systemic fungicide belongs to the class of pyrimidines, triazoles, strobilurins, triazolinthiones, succinate dehydrogenase inhibitor (SDHI) fungicides, piperidines, morpholine analogue fungicides, sulphur fungicide or a combination thereof.

49. The composition of claim 47, wherein the systemic fungicide is tebuconazole, prothioconazole, bixafen, trifloxystrobin, cyproconazole, cyprodinil, fenpropidin, propiconazole, chlorothalonil or benzovindiflupyr.

50. The composition of any one of claims 44-49, wherein the fungicide is in an amount of at least 40%, 45%, 50%, 55%, 60%, 65%, 70% or 75% of the recommended dose.

51. The use of any one of claims 1, 2, 5 and 20-33, the method of any one of claims 3-14 and 18-43, or the composition of any one of claims 44-50, wherein the amount of the fungicide is reduced by from 5% to 95%.

52. The use, method or composition of claim 51, wherein the amount of the fungicide is reduced by at least about 5%, at least about 10%, at least about 20%, at least about 30%, at least about 40%, or at least about 50%, about 60%, at least about 70%, at least about 80%, at least about 90%, or at least about 95%.

53. The use of any one of claims 1, 2, 5, 12-14, 20-33 and 51-52, or the method of any one of claims 3-14 and 18-43, which comprises sequentially applying to the plant, soil or the vicinity of the plant a first combination of at least one fungicide and glycine betaine and a second combination of at least one fungicide and glycine betaine, wherein said second combination comprises at least one fungicide not present in said first combination.

54. The use or method of claim 53, comprising sequentially applying to the plant, soil or the vicinity of the plant one or more additional combinations of at least one fungicide and glycine betaine, wherein a said additional combination comprises at least one fungicide not present in a previous combination.

55. The use of any one of claims 1, 2, 5, 12-14, 20-33 and 51-54, or the method of any one of claims 3-14 and 18-54, comprising applying at least one fungicide and glycine betaine at a second node stage of said plant.

56. The use of any one of claims 1, 2, 5, 12-14, 20-33 and 51-55, or the method of any one of claims 3-14 and 18-55, comprising applying at least one fungicide and glycine betaine at a final stage of leaf pointing or spreading of said plant.

57. The use of any one of claims 1, 2, 5, 12-14, 20-33 and 51-56, or the method of any one of claims 3-14 and 18-56, comprising applying at least one fungicide and glycine betaine between heading and flowering of said plant.

58. The use or method according to claim 55, wherein said at least one fungicide comprises tebuconazole, metconazole, chlorothalonil, prochloraze, a sulphur fungicide, strobilurine or a combination thereof.

59. The use or method according to claim 56, wherein said at least one fungicide comprises tebuconazole, metconazole, epoxiconazole, cyproconazole, fluxapyroxad, bizafen, benzovindiflupyr or a combination thereof.

60. The use or method according to claim 57, wherein said at least one fungicide comprises prothioconazole, difenoconazole, tebuconazole, metconazole, epoxiconazole or a combination thereof.

61. The use or method according to claim 60, wherein said at least one fungicide comprises prothioconazole and/or difenoconazole.
